(19) United States
(12) Patent Application Publication
(10) Pub. No.: US 2009/0053111 A1
(43) Pub. Date: Feb. 26, 2009

(54) METHOD OF PRIORITISING A SAMPLE

(75) Inventor: Andrew James Francis, Queensland (AU)

Correspondence Address: DENNISON, SCHULTZ & MACDONALD, 1727 KING STREET, SUITE 105, ALEXANDRIA, VA, 22314, US

(73) Assignee: AYZALA PTY LTD.

(21) Appl. No.: 10/584,801

(22) PCT Filed: Dec. 31, 2004
(86) PCT No.: PCT/AU2004/001839

§ 371 Date: Jun. 28, 2006

(30) Foreign Application Priority Data
Dec. 31, 2003 (AU) 2003907169
Mar. 3, 2004 (AU) 2004901072

(51) Int. Cl. B01L 3/00; B32B 37/00

(52) U.S. Cl. 422/102; 156/60

(57) ABSTRACT

A method or prioritizing a sample, the method comprising the steps of incorporating an indicator band (14) around a specimen container (12) wherein the indicator band (14) is incorporated on a body of the specimen container (12) prior to a sample being located within a body of the specimen container (12).

### FIELD OF THE INVENTION

This invention relates to a method of prioritizing a sample. In particular, the invention relates to prioritizing the testing of a biological sample obtained from a patient and therefore will be described in this context. However, it should be appreciated that the method may also be used to prioritize other samples such as those obtained from animals.

### BACKGROUND OF THE INVENTION

Specimen containers are used to collect, transport and process biological samples, such as blood, urine, feces, infected material, tissue etc., from patients for testing purposes. It should be appreciated that the term “specimen container” may include any form of container including tubes, buckets, cups or the like containers.

Specimen containers usually have a label located on the specimen container that is applied during production of the specimen container so that details of the patient can be recorded. Once the biological samples are collected, they are then usually tested in a pathology laboratory to determine if the patient is unwell or suffering from a disease. Other samples may undergo different types of laboratory testing including cultivation and/or culture and/or nucleic acid testing.

There are many steps in a Request-Test-Report cycle for pathology investigations:
Request (may include data entry—e.g. electronic request system)
Sample collection
Sample transportation
Sample delivery/arrival
Sample reception/registration (may include data entry)
Pre-analytical sample processing e.g. centrifugation +/−aliquots
Sample testing
Result validation/verification
Sample storage
Report delivery
Review of results by the clinical staff (referring doctors etc)

For routine tests, a delay in the testing process is generally of little consequence. However, for urgent/high priority samples (e.g. from the Emergency Department or the Intensive Care Unit), a delay at any one of these steps can cause the results of the tests to be unavailable when required for the appropriate and timely management of patients.

These delays cause patients to miss having the appropriate care within the clinically specified time frames for best practice (e.g. appropriate and timely management of myocardial ischaemia). The delays can cause patient harm. Some patients die while waiting for results of tests where results indicate treatable conditions. In terms of the healthcare system, patients spend unnecessarily long times on beds or trolleys in the Emergency Department. There is a financial and human cost of this delay and the cost of a slow throughput in the Emergency Department is substantial. The cost of each minute of clinical staff time (doctors, nurses, nursing assistants, etc.) is significant—especially if they are simply waiting for results of pathology investigations to be available so that they are then able to manage patients who are waiting.

In terms of the Request-Test-Report cycle, there are many steps as listed above. Many of these steps are manual and often involve a significant number of different individuals. At each of these steps, there is the potential for any individual specimen to inadvertently be delayed. Human error and the lack of an integrated system contribute to a significant failure rate in the testing and delivery of results for tests where there has been an urgent request.

The clinical need for results in an urgent time frame is usually identified at the time of the test request—either in paper form or on an electronic request system. This information regarding test urgency on the request or request form may be missed at the time of specimen collection, may be missed during specimen transportation, or may be missed at the time of sample receipt or processing in the laboratory. Additionally, in many laboratories, the request form is separated from the specimen. Unfortunately, once an error has occurred there is often no opportunity to detect deviation from the ideal rapid passage through the Request-Test-Report cycle or to implement a corrective action to rectify this deviation.

To try to overcome this, a variety of approaches have been taken that have included a change of lid colour of specimen containers to indicate urgency, but this colour change has removed other critical information regarding the nature of the container and the anti-coagulant/preservative that is in the container. Containers use internationally recognised lid colours to indicate the anticoagulant inside and therefore the suitability of the sample inside the container for different specific tests. Hence, changing the colour of the lid is generally not preferred. Also, the lid of the container is often removed for specimen processing, and therefore any marker of urgency is lost from the sample if the urgent marker is only on the lid.

A variety of other styles of markers have also been attempted, but these are applied manually part way through the Request-Test-Report cycle. The problems encountered with this approach are that again human error means that they may fail to be applied (omitted), are unreliably applied, and/or incorrectly applied, they may become dislodged, and, if they have been applied to the specimen container lid, they are deliberately removed from the sample during testing for many specimens/tests.

Yet another approach has been to photocopy each urgent request form to try to alert staff that one of the many samples they are handling must be processed urgently. This is expensive, inefficient, ineffective, and unreliable.

The consequence of these failings is that everyday in every laboratory in the world some urgent samples are not processed urgently and consequently have a significantly delayed turn around time. For some patients, care is compromised and patients can and do die or suffer a major adverse event. For some patients, there is a significant delay within the healthcare system and this has a personal cost to the patient and a huge financial cost to the healthcare system.

One approach to address problems with laboratory turn around times has been to implement laboratory automation. This often incurs a substantial capital investment and is not appropriate for all laboratories. While laboratory automation can assist with a global improvement in turn around times, it only addresses a relatively small portion of the entire Request-Test-Report cycle. Additionally, current laboratory automation systems rely on a manual or human bypass to deal with urgent samples. This manual approach is accompanied by all of the failures suggested above.

Another approach to address problems with laboratory turn around times has been to introduce Point of Care Testing or Near Patient Testing. There is certainly a role for this within the healthcare system. However, at this point in time, systems are too slow, too expensive, and too cumbersome to provide an effective solution if a number of tests are required when compared to an on-site laboratory using high throughput automated laboratory instruments. It is not practical or cost-effective for doctors and nurses near the patient to use 45-60 minutes of their time, a number of different small instruments, a number of different test consumables (e.g. cartridges) and a number of different patient sample types to obtain the same (or often less) information than an on-site laboratory can rapidly provide. An onsite laboratory can provide more comprehensive information (more test parameters/results), in less time, at less cost, and without using the time and resources of healthcare staff who are better utilised caring for sick patients (e.g. doctors and nurses in the Emergency Department).

In 2003, the Australian Council on Healthcare Standards (ACHS) published a report titled “Determining the Potential to Improve Quality of Care 4^{th} ed-ACHS Clinical Indicator Results for Australia and New Zealand 1998-2002”. Over a five year period, data was collected from between 14-25 hospitals with on-site laboratories. Data was obtained from all States in Australia and from New Zealand and included public and private healthcare facilities, large and small laboratories, metropolitan and rural laboratories.

This report highlighted major deficiencies in laboratory turn around times for urgent tests. Conservatively, this report demonstrated that on-site laboratories failed to deliver results within an acceptable turn around time in 5-20% of urgent cases. The mean failure rate for a request for some tests was 33% and, in some States of Australia, 60% of urgent specimens failed to have results available within a clinically appropriate time frame.

Inquiries with laboratories in Australia and Europe confirmed that the fastest 30% of urgent samples are tested and generally completed in clinically appropriate time frames. However, the slowest 30% can take more than 8 times longer. This then confirms the ACHS data and reflects on the inadequacies of the current systems in all laboratories in reliably delivering results for urgent samples within a clinically appropriate turn around time for an acceptably high percentage of samples.

The ACHS data also highlights that there are real ceilings of capability utilising the current strategies. The data over the five year period generally shows fluctuations around common values rather than progressive and continued improvement. Depending on the specific tests, the current systems appear to be incapable of reliably delivery results for urgent specimens within clinically appropriate time frames for more than 79-92% of samples. A failure rate of 8-21% or more is considered to be not acceptable in a high quality healthcare system.

The following is ACHS data for urgent test specimens (percent of urgent specimens having results available within a specified clinically appropriate turn around time target). The mean is the mean percent of urgent specimens having results available within the specified turn around time target for all laboratories and the 80^{th} percentile is the percent of urgent specimens having results available within the specified turn around time target for the best performing 80% of laboratories (i.e. the worst 20% of laboratories are excluded) (abbreviations K=plasma potassium, Hb=Haemoglobin):

| | K+ (normal hours) | | K+ (out of hours) | | Hb (normal hours) | | Hb (out of hours) | |
|---|---|---|---|---|---|---|---|---|
| | | 80^{th} | | 80^{th} | | 80^{th} | | 80^{th} |
| Year | Mean | percentile | Mean | percentile | Mean | percentile | Mean | percentile |
| 1998 | 58.4% | 73.5% | 53.3% | 80.1% | 81.7% | 92.1% | 83.1% | 91.6% |
| 1999 | 64.0% | 84.1% | 71.9% | 90.9% | 88.1% | 92.1% | 80.8% | 91.7% |
| 2000 | 66.1% | 79.5% | 76.2% | 84.3% | 89.0% | 93.2% | 87.2% | 90.6% |
| 2001 | 61.1% | 80.5% | 71.8% | 85.9% | 88.0% | 92.2% | 87.2% | 90.6% |
| 2002 | 66.5% | 78.7% | 74.4% | 85.9% | 84.8% | 91.7% | 80.3% | 91.2% |

Indeed, the ACHS report states that the causes of variations and delays in turn around time need to be determined and that “those causes that are system related could be the object of a quality improvement program to redesign the pathology processes”. The ACHS report uses the data within the report to demonstrate that, because the failure rates are so high, improvements in the process that deliver gains could benefit up to 10 000 patients within each of their patient sample sets containing approximately 80 000 patients in each of their report categories.

The United States Institute of Medicine of the National Academies has produced a number of reports in recent years highlighting the urgent need to address significant issues in relation to healthcare and quality. There are also two Institute of Medicine (IOM) reports to address critical issues of inadequate safety and quality in the American Health Care System, “To Err is Human: Building a Safer Health System” (2003) and “Crossing the Quality Chasm: A New Health System for the 21^{st} Century” (2001).

Indeed, “Crossing the Quality Chasm: A New Health System for the 21^{st} Century” (2001) highlights that Six aims for Healthcare in the 21^{st} Century are:
Safe
Patient Centred
Efficient
Effective
Timely
Equitable

Failure to reliably deliver results on urgent specimens within a clinically appropriate time frame fails these aims in a variety of ways—it is not Timely, it is not Efficient, and it is not Patient Centred if patients spend unnecessary hours waiting for treatment or management discharge decisions simply because pathology results are delayed. Further, it is not Equitable if patients with the slowest 30% of pathology turn around times have an unnecessary wait/delay compared to patients with the fastest 30% of pathology turn around times—simply because the pathology processes are inadequate in delivering the same reliable and rapid service to all patients requiring urgent tests.

Worldwide it is estimated that there are approximately 400 million samples each year in OECD countries that require tests to be performed urgently (approximately 10% of annual pathology tests). With a failure to perform these tests within an appropriate time frame in 8-30% of samples, there are potentially 32-120 million instances each year in OECD countries where patient care is delayed or compromised because of inadequacies in the current approaches to testing urgent pathology specimens.

Current pathology processes and systems for the handling of urgent or priority samples have significant shortcomings that contribute to compromised patient care, adverse patient events, and major expense for healthcare systems around the world.

### OBJECT OF THE INVENTION

It is an object of the invention to overcome or alleviate one or more of the above disadvantages or provide the consumer with a useful or commercial choice.

### SUMMARY OF THE INVENTION

In one form, although not necessarily the only or broadest form, the invention resides in a method of prioritizing a sample, the method comprising the steps of:

incorporating an indicator band around a body of a specimen container

wherein the indicator band is incorporated on a body of the specimen container prior to a sample being located within the body of the specimen container.

Preferably, the indicator is located on the body adjacent an opening of the specimen container.

A lid indicator may extend around the lid of the specimen container or form part of the top of the lid of the specimen container.

The indicator band may form part of a label that is applied to the specimen container. Alternatively, the indicator may be integral with the specimen container. Still alternatively, the indicator may be printed onto the specimen container.

The indicator may include a human readable element (for example, words) and a machine readable element (for example, a bar code) to indicate the priority and/or level of prioritization of the sample and may include a grading system. Alternatively, different coloured indicators and/or different styles of indicators may be used to inform different levels or gradings of prioritization

Preferably, the indicator is brightly coloured and/or sized so that it is visible from a distance.

The indicator may also include a human readable and/or a machine readable element (for example, a bar code) specifying the urgency of the sample/specimen.

In another form, the invention resides in a specimen container comprising:

a body for placement of a specimen; and

an indicator band extending around the body;

wherein the band is brightly coloured to be visible from a distance.

Preferably, the specimen container includes a lid for placement on the body of the specimen container.

Preferably, the indicator band extends entirely around the specimen container.

Normally the indicator band is a continuous band. However, it is envisaged that the band may be non-continuous.

Preferably, the indicator is located on the body adjacent an opening of the body.

The indicator band is normally between 1 mm and 20 mm wide in order that the band can be viewed from a distance. Usually, the indicator band is between 2 mm and 10 mm wide. Preferably, the indicator band is between 2.5 mm and 5 mm wide.

The colour of the indicator band is brightly coloured. Using colour as defined as hue, saturation and brightness, the hue can be of any colour other than black or white. Preferably colours include red (0 degrees), yellow (60 degrees), green (108 degrees), cyan (180 degrees), orange (12 degrees), purple (288 degrees), and magenta (300 degrees).

The brightness of the colour of the indicator band is normally greater than 40%. Preferably, the colour of the indicator band has a brightness of greater than 60%. More preferably, the colour of the indicator band has a brightness of greater than 80%.

Normally, the colour of the indicator band has a saturation of greater than 40%. Preferably, the colour of the indicator band has a saturation of greater than 60%. More preferably, the colour of the indicator band has a saturation of greater than 80%.

Preferably the indicator band is fluorescent.

Preferably, the indicator band is visible whether the specimen container has an attached lid that is completely or partially attached or whether the lid is absent or has been removed.

The indicator band may form part of a label that is applied to the specimen container. Alternatively, the indicator band may be integral with the specimen container. Still alternatively, the indicator band may be printed onto the specimen container.

The indicator band may include a human readable element (for example, words) and a machine readable element (for example a bar code) to indicate the priority and/or level of prioritization of the sample and may include a grading system. Alternatively, different coloured indicators and/or different styles of indicators may be used to inform different levels or gradings of prioritization.

The indicator band may have a removable and adherent portion or include a removable tag and/or an adhesive removable tag.

A details section may be blank allowing for the recordal of patient information or may include specific locations for the surname, first name, date of birth, time, date, signature, ward, patient number or similar details.

The details section may also include a fill line, that when applied to a body of the specimen container, indicates the level of fluid that the body is to be filled to.

The details section may also include a location for the sample type.

The details section may also include a batch number and/or expiry details and/or date of manufacture of the container.

The details section may also include a biohazard and/or radiation marker or symbol and/or some other hazard or warning symbol

The details section may also include a human readable and machine readable element (for example, a bar code) specifying a laboratory or sample number that may also have a removable and adherent portion of the same human readable and machine readable element (for example, a bar code number).

The details section may also include a human readable and a machine readable element (for example, a bar code) specifying the urgency/priority and/or level of prioritization of the sample and may include a grading system.

Preferably, the indicator band is brightly coloured and/or sized so that it is visible from a distance.

Preferably the indicator band is fluorescent.

In another form, the invention comprises a specimen container label compromising:

an indicator band to extend around a body of a specimen container; and
a removable tag for placement on an article;

wherein the indicator band is brightly coloured to be visible from a distance.

In yet another form, the invention resides in a specimen container label compromising:
an indicator band to extend around a body of a specimen container; and
a details section to allow for the recordal of the details of a patient;

wherein the indicator band is brightly coloured to be visible from a distance.

### DETAILED DESCRIPTION OF DRAWINGS

Embodiments of the invention, by way of examples only, will be described with reference to the accompanying drawings in which:

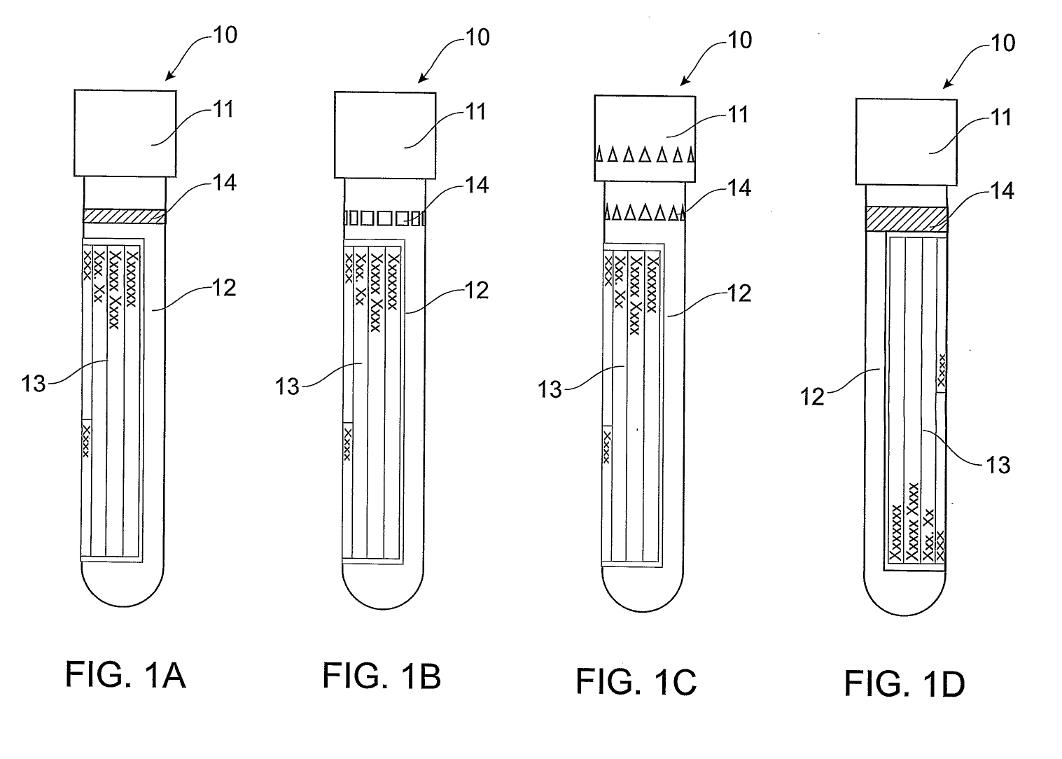

FIGS. 1A to 1D show different embodiments of indicator bands that have been applied to a specimen container;

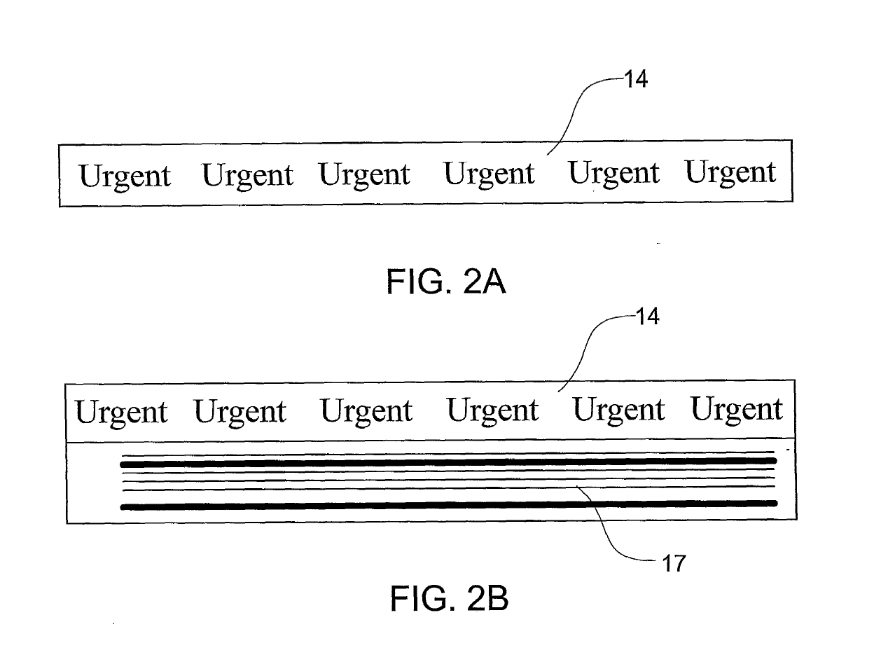

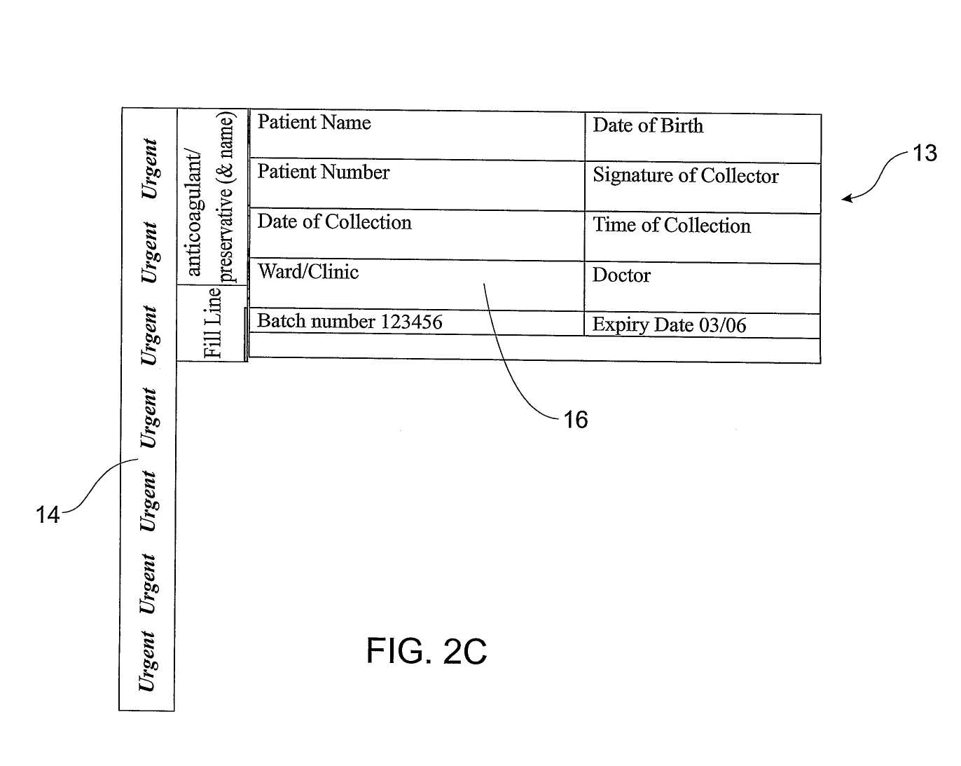

FIG. 2A to 2C show different embodiments of labels to be applied to specimen containers.

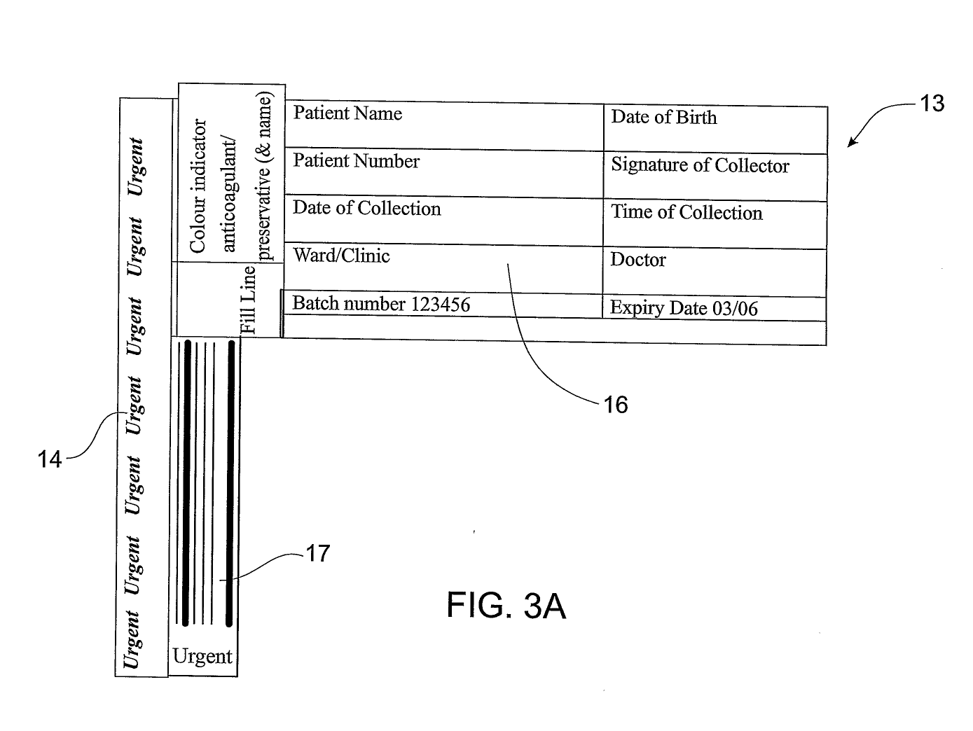

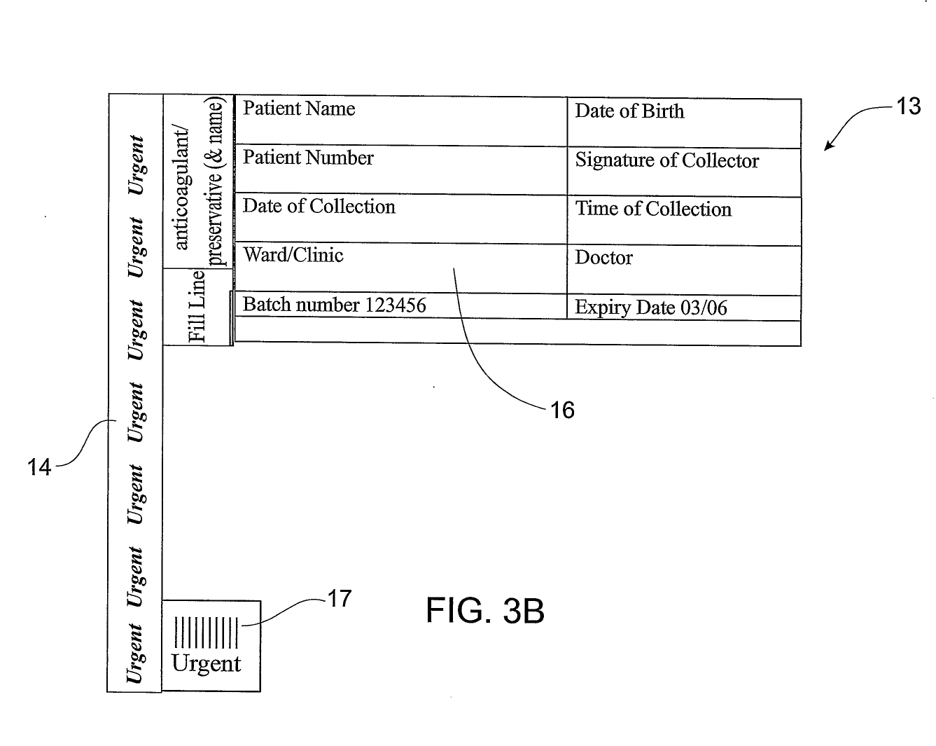

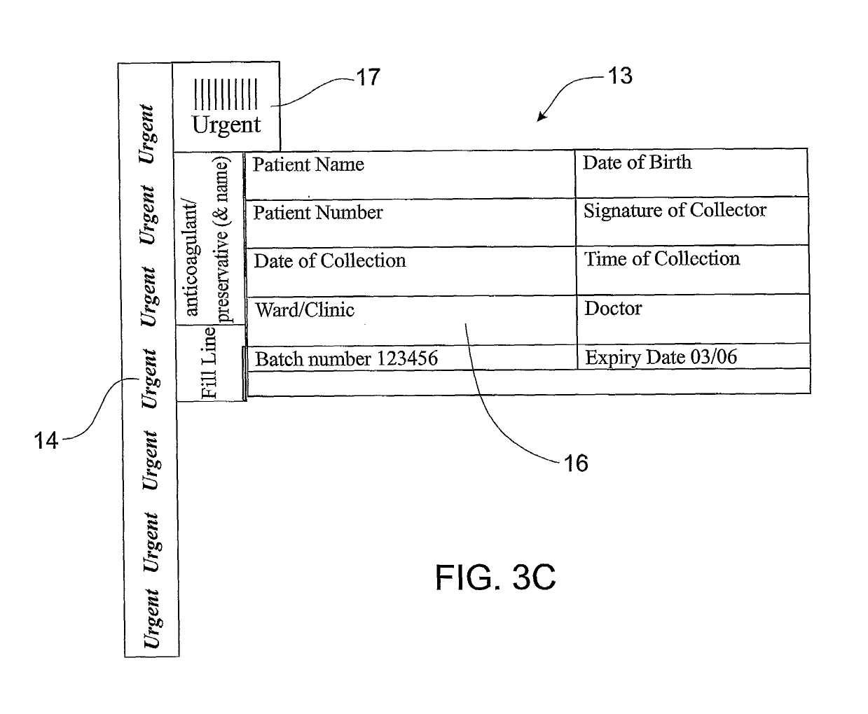

FIG. 3A to 3C shows yet another embodiment of the invention; and

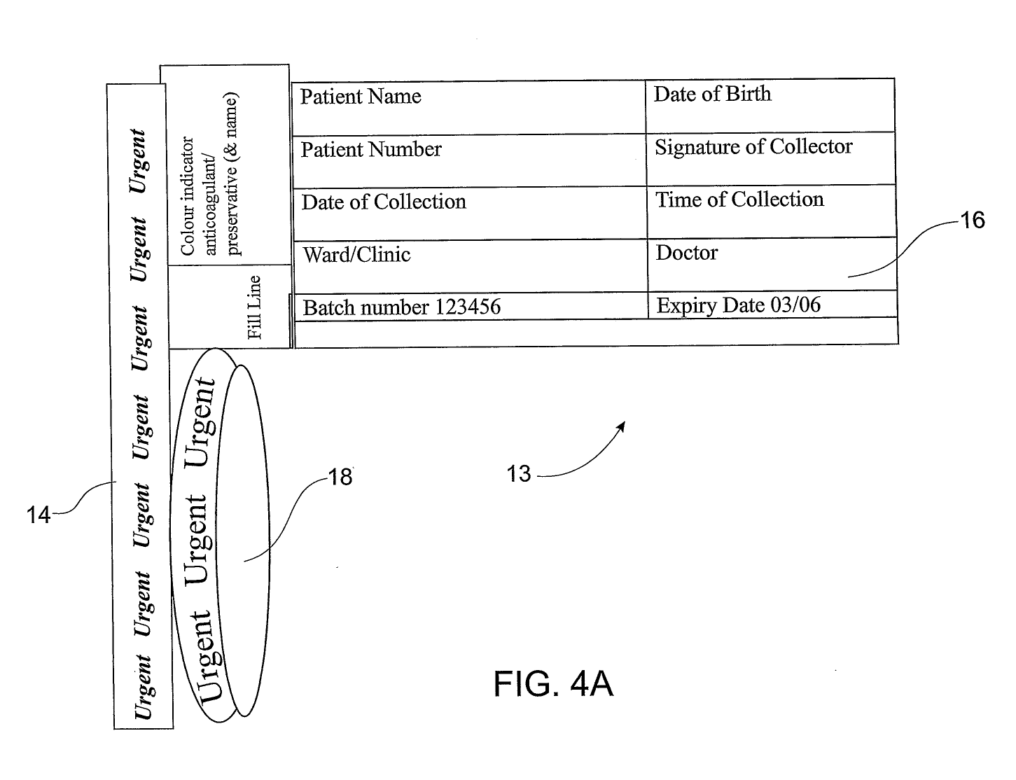

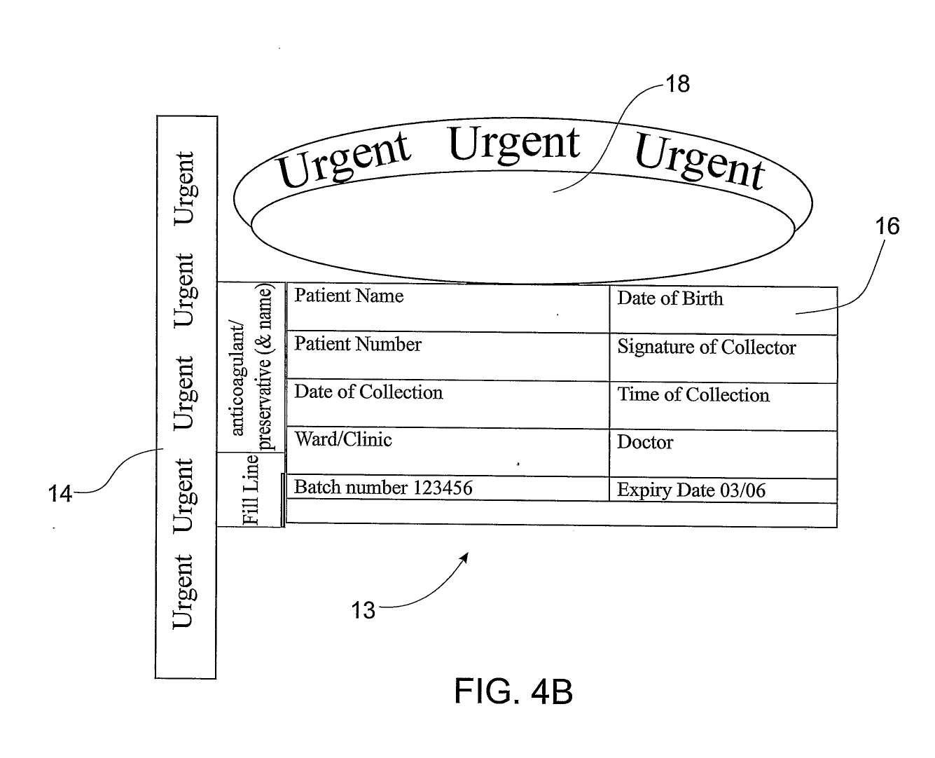

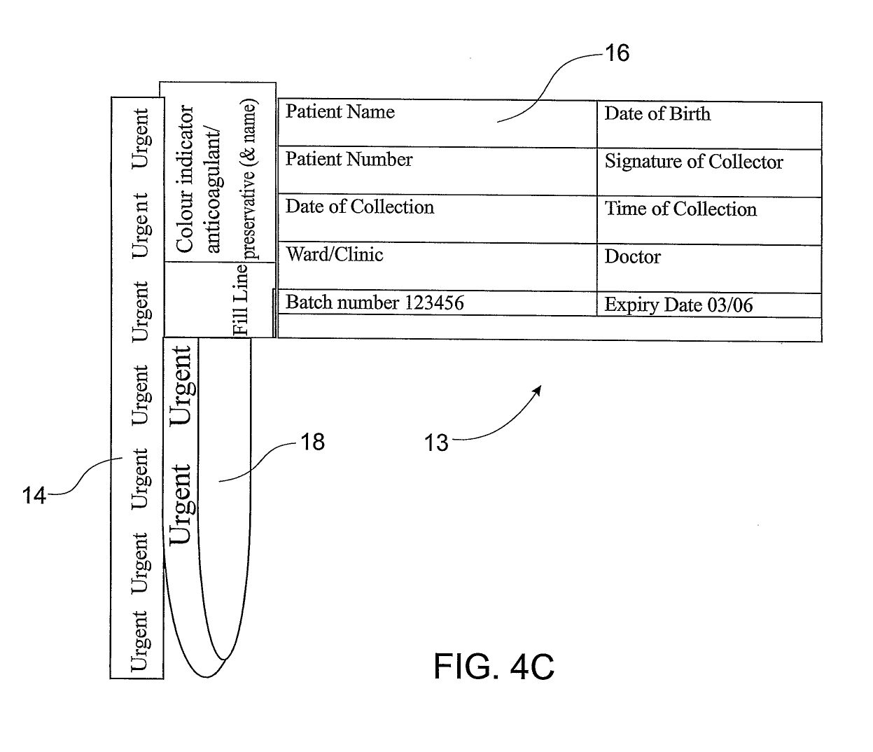

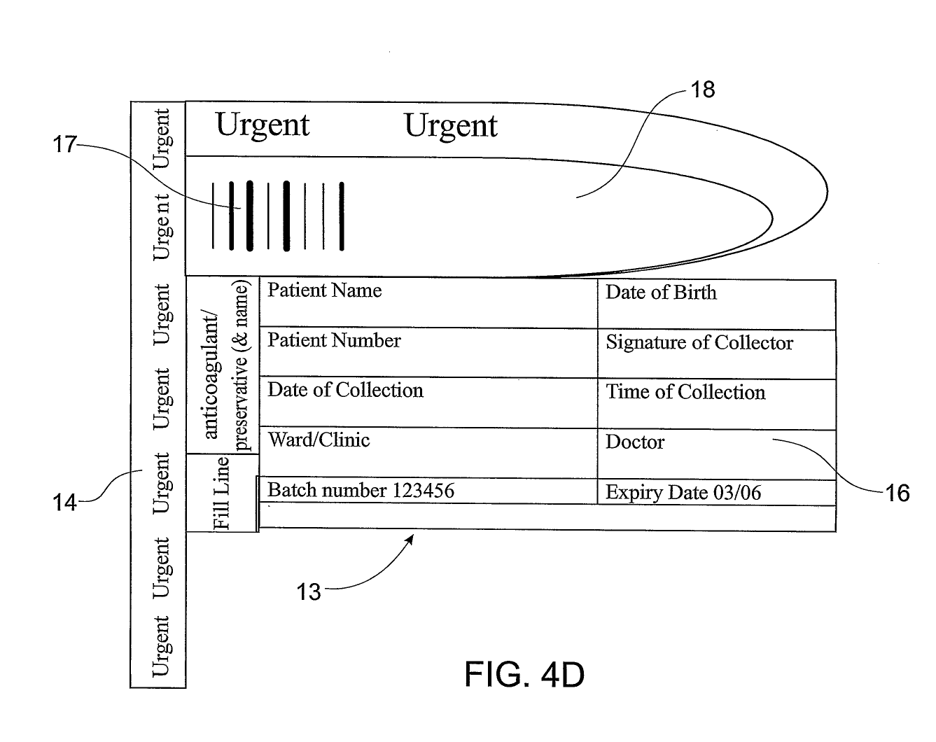

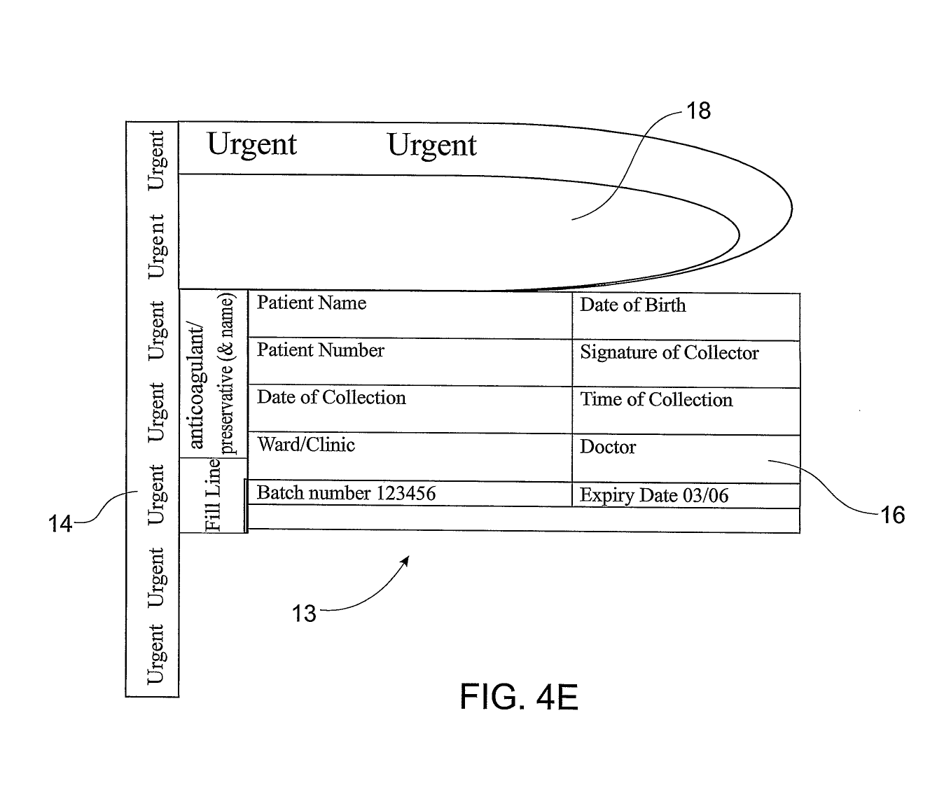

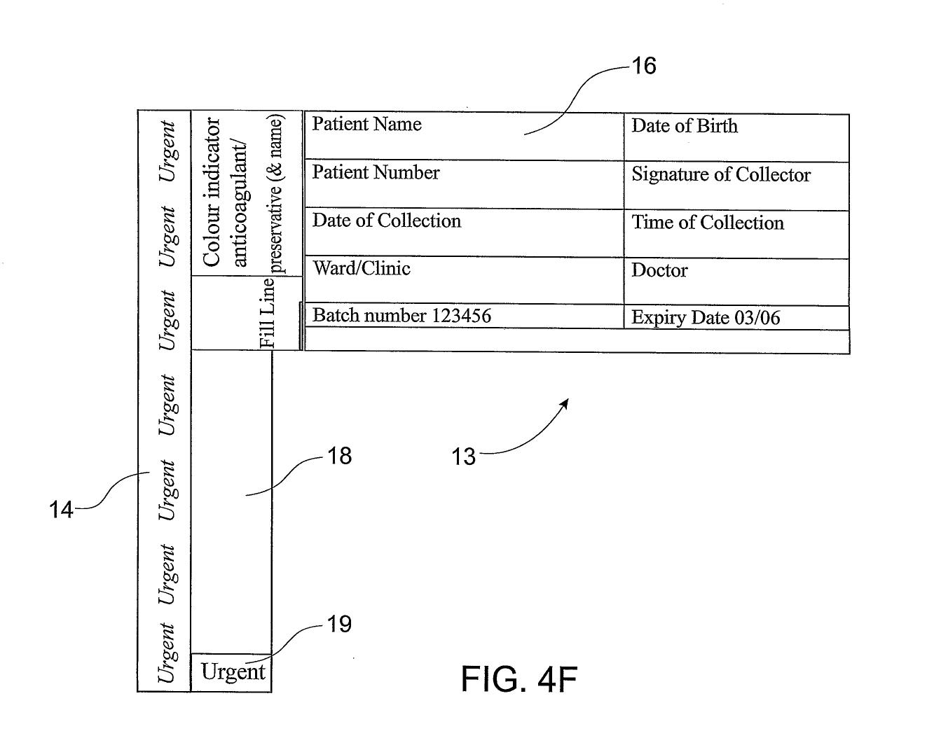

FIG. 4A to 4F show still yet other embodiments of the invention;

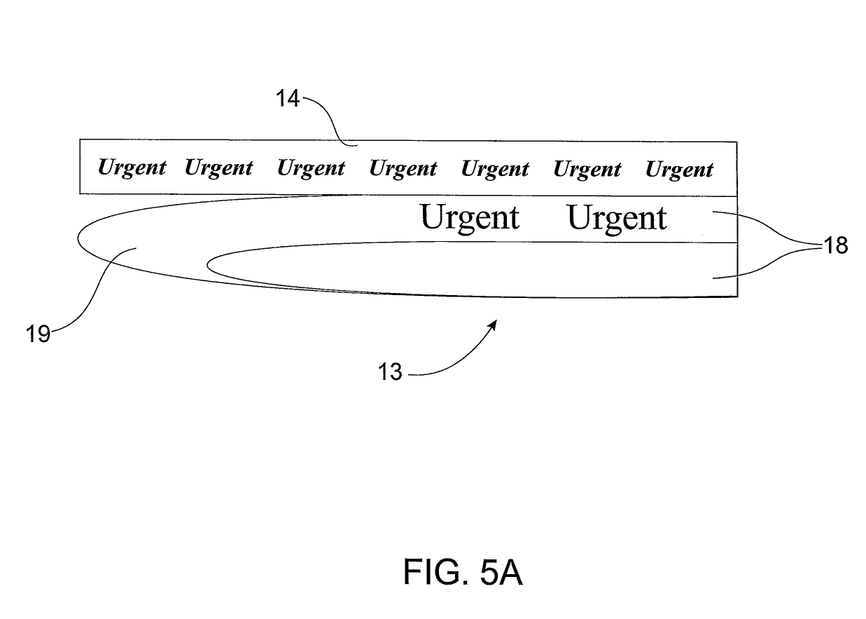

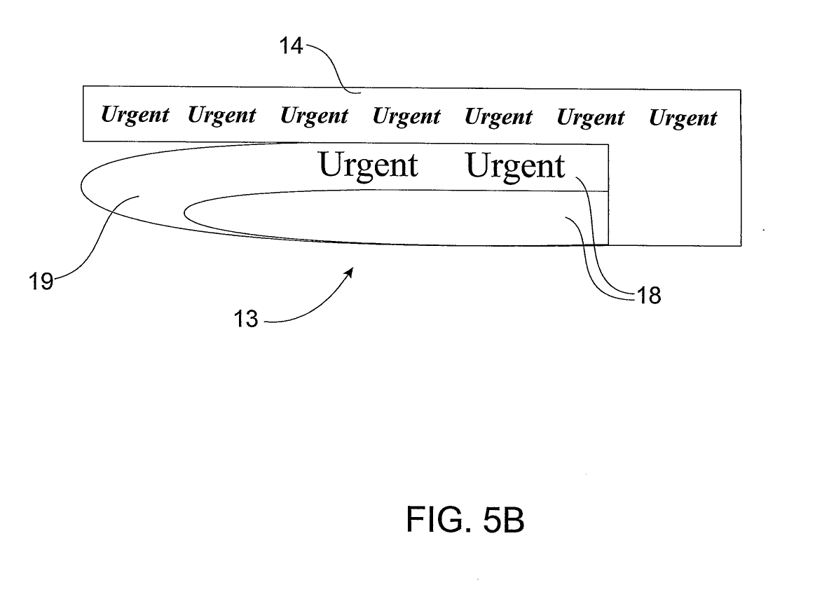

FIG. 5A to 5B show different embodiments of labels to be applied to specimen containers.

### DETAILED DESCRIPTION OF A PREFERRED EMBODIMENT

FIGS. 1A to 1D show specimen containers 10 that are typically used for the collection of blood. Each specimen container has a lid 11 and a body 12. The body 12 is used to contain a blood sample whilst the lid 11 is removable from the container and seals an opening contained within the body 12 through which the blood is located within the body 12.

Each specimen container 10 also has a label 13 located on the container. The label 13 is a sticker that is applied to the specimen container during manufacture i.e., in production. The label 13 is sized so that it only extends partially around the body 12 so that a viewing window is left on the container to view the level of blood within the body 12.

The label 13 has a details section 16 that includes discrete labelled zones for surname, first name, date of birth, time that the sample was taken, signature of the person who took the same, the ward number, and patient number. However, it should be appreciated that the details label may be varied according to specific requirements.

The label also includes a fill line that indicates the level of fluid that the body is to be filled to. The fill line must be precisely located with respect to the body and hence a major reason why the label is applied to the body during manufacture.

FIG. 1A shows the specimen container with a label 13 and a separate label in the form of an indicator band 14. The indicator band 14 is located above this label 13 on the body 12 of the specimen container 10. In this embodiment, the indicator band 14 is in the form of band that extends continuously around the circumference of the body.

The indicator band is 2.5 mm wide. The indicator band is coloured having a hue of magenta (300 degrees), a saturation of 95% and a brightness of 90%. It should be appreciated that the colour of the band may be varied according to preference. The indicator band is also fluorescent. Due to the colour, size and fluorescence of the indicator band the specimen container is visible from a distance and hence can be readily identified by a person and can be easily recognised as a container than must be given priority during all stages of the Request-Test-Report cycle.

FIG. 1B shows a very similar label 13 to FIG. 1A. In this embodiment, the indicator band 14 is printed onto the body 12 and is in the form of a dotted band that extends around the circumference of the body 12.

FIG. 1C shows an indicator band 14 located on the lid 11 and the body 12 of the container 10. The indicator band 14 is in the form of two bands of triangles that extend around the lid 11 and the body 12 of the container 10. The indicator band 14, in this embodiment, is a non-continuous band.

FIG. 1D shows an indicator band 14 that is integrally formed with the details section. The label includes a details section and the indicator band in the form of an indicator band 14.

FIG. 2A shows a label in the form of an indicator band 14 that is to be placed onto a body of a specimen container. The indicator band is 4 mm wide and of a length so that the indicator fits entirely around the body of the specimen container. The indicator band is coloured having a hue of green (90 degrees), a saturation of 100% and a brightness of 85%. A human readable element in the form of the words URGENT is repeated along the length of the indicator band.

FIG. 2B shows yet another embodiment of a label indicator band 14. This label has an indicator band 14 that includes a human readable element and a machine readable tag 17 integrally formed with the indicator band. Prioritization information is incorporated into the machine readable tag 17 so that when the machine readable tag is scanned, the prioritization information of the label is electronically transferred to laboratory instruments, the laboratory information system and/or other appropriate electronic devices.

FIG. 2C shows a label incorporating an indicator band 14 and details section 16 prior to it being placed on the body of the specimen container. As can be seen, the details section 16 carries the standard elements of a standard label as described above.

The indicator band 14 is substantially longer than the details section 16. The indicator band extends entirely around the body 12 whilst the details section 16 only extends partially around the body 12. This allows a window to view the sample as outlined above.

In this embodiment, the details section 16 is located adjacent one end of the indicator band 14.

FIGS. 3A, 3B and 3C show further embodiments of a label 13 similar to that shown in FIG. 2C. An indicator band 14 and details section 16 are integrally formed as in the previous embodiments. However, the label 13 shown in FIGS. 3A to 3C has a machine readable tag 17 located on the label 13. The machine readable tag 17 incorporates the prioritization indicator information into the machine readable tag 17 so that when the machine readable tag 17 is scanned, the prioritization information of the indicator is electronically transferred to laboratory instruments, the laboratory information system and/or other appropriate electronic devices.

FIGS. 4A to 4F show further variations of the label of FIG. 2C. In each of these embodiments a removable tag is provided.

The removable tag includes the visual marker and a human readable element i.e. the word “URGENT”. The removable tag includes an area that can be printed on or written on (e.g. the names of tests, the instrument on which the tests are to be done, the time of sample collection, the time that results are needed, who will follow-up the results, etc.).

The removable tag 18 is used to place on associated paperwork work to further increase the awareness that the sample that is collected must be processed urgently. The removable tag can be applied to (stuck on) the pathology request form, the specimen bag or transport container, a daughter or aliquot specimen tube/container, into the patient notes/medical record, onto a patient management work list or sheet, etc. However, it should be appreciated that the removable tag may be varied according to specific requirements and the use to which the removable tag is put may be varied according to specific requirements.

FIGS. 5A and 5B show an indicator band attached to a removable tag.

In FIGS. 4A to 4F and 5A and 5B, the removable tag has an adhesive backing. The removable tag in each embodiment may be attached to the indicator band at various locations to enable the removable tag to readily be removed. In each of these FIGS, the removable tag has a coloured section 19 that has the same colour properties as the attached/adjacent indicator band and a blank section for printing or writing of specific information regarding that particular patient or specimen.

It should be appreciated that by incorporating the indicator band into the specimen container during production, this will automate the process making the container for urgent samples cheaper to produce.

Further, existing machinery, such as the label applicators, can be simply modified to place the label with the integrated indicator band onto the body of the container. Further, the utilisation of specimen containers with incorporated indicator bands will, by the immediate and permanent link between the sample and the incorporated indicator band, and by the easy visual and machine identification of urgent samples from a distance to all people handling the specimen containers, assist in expediting the testing process from sample collection through sample transportation, sample receipt in the laboratory, laboratory testing, result validation/verification, report production, report delivery and sample storage, through to review of results by clinicians.

Further, the utilisation of specimen containers with incorporated indicator bands will enable ready and rapid detection when there is deviation from the ideal rapid passage through the Request-Test-Report cycle for urgent specimens at each and every step in the cycle. This detection then permits the rapid implementation of a corrective action to rectify this deviation to ensure that results for urgent samples are delivered within specified clinically appropriate turn around times.

Further, the utilisation of specimen containers with incorporated indicator bands will eliminate the risk of failure to recognize a high priority sample at each and every step in the Request-Test-Report cycle and/or the separately applied priority indicator being omitted from being applied part way through the cycle, or becoming dislodged or removed.

Further, the utilisation of specimen containers with incorporated indicator bands will expedite the testing process when no accompanying paperwork has been received or if requested tests are ordered electronically.

### EXAMPLE

A small pilot trial using sample containers with an incorporated priority indicator, as shown in FIG. 1A, was used on a small scale in an Emergency Department. The use of the specimen containers demonstrated a significant reduction in the number of samples that failed to have results for urgent specimens from an Emergency Department available within the specified turn around time targets. The results were as follows:

There was a 53% reduction in the failure rate (reduced from 16.5% to 7.7%) by using specimen containers with an incorporated priority indicator. This study only looked at the “within laboratory” component of testing (i.e. registration of the request onto the Laboratory Information System after receipt of the sample in the laboratory until result availability for clinicians).

It should also be appreciated that various other changes and modifications may be made without departing from the spirit or scope of the invention.

1-30. (canceled)

31. A specimen container comprising:
a body having an opening for placement of a specimen;
a lid to cover the opening of the body; and
a substantially continuous indicator band extending around the body; the band being located on the body adjacent the opening and viewable when the lid is placed over the opening, wherein the indicator band is incorporated on the body of the container prior to a specimen being located within the body of the container.

32. The specimen container of claim 31 wherein the indicator band is a label that is applied to the body.

33. The specimen container of claim 31 wherein the indicator band is integrally formed with the body.

34. The specimen container of claim 31 wherein the indicator band is printed on the body.

35. The specimen container of claim 31 wherein the indicator band includes a human and/or machine readable element.

36. The specimen container of claim 31 wherein the indicator band includes a removable tag.

37. The specimen container of claim 36 wherein the removable tag is an adhesive tag.

38. A method of color coding a specimen container, the method comprising the steps of:
incorporating a colored indicator band extending around a body of a specimen container adjacent an opening of the body so that when a lid is placed over the opening, the indicator band is viewable,
wherein the indicator band is incorporated on a body of the specimen container prior to a sample being located within the body of the container.

39. The method of claim 38 further including the step of the indicator band being incorporated around the body of the container during production of the container.

40. The method of claim 38 further including the step of adhering the indicator band to the container.

41. The method of claim 38 further including the step of integrally forming the indicator band with the container.

42. The method of claim 38 further including the step of printing the indicator band on the container.

43. A method of operating a medical clinic, including:
receiving or preparing unused specimen containers having priority indicators on the bodies of the containers,
receiving or preparing unused specimen containers without priority indicators,
determining whether patients passing through the clinic require priority or non-priority treatment,
selecting unused specimen containers with or without priority indicators according to the priority required for the respective patients,
filling the selected priority or non-priority containers with specimens taken from the respective patients, labeling the respective containers, and
sending the filled and labeled containers to a laboratory for testing in accord with their respective labels and priority indicators.

44. An unused specimen container for use in the method of claim 43, having a body with an opening for receipt of a specimen, and a priority indicator on the body which is visible when a lid is in place to close the opening.

45. A container according to claim 44 wherein the priority indicator is a colored band which extends substantially around the body, adjacent the opening.

46. A container according to claim 44 wherein the priority indicator is integral with a data label.

47. A priority specimen container for use in assessment of patients, having a body with an opening for receipt of a specimen from a patient, a lid which closes the opening, and a priority indicator which is located on the body adjacent the opening.

48. A container according to claim 47 wherein the priority indicator is a colored band which extends substantially around the body.

49. A container according to claim 47 wherein the priority indicator is integral with a data label.

50. A method of processing a specimen from a patient, including:
determining that the patient requires urgent testing of a specimen,
selecting an unused specimen container having a priority indicator on the body of the container,
collecting a specimen from the patient using the selected container, and
sending the container with the specimen to a laboratory for the testing.

51. A method according to claim 50 further including:
registering the priority of the container at the laboratory,
carrying out the urgent testing with priority over specimens in containers not having priority indicators, and
sending an urgent report with results of the testing to a required destination.
